(19) United States
(12) Patent Application Publication
(10) Pub. No.: US 2020/0192006 A1
(43) Pub. Date: Jun. 18, 2020

(54) OPTOELECTRONIC SENSOR AND METHOD FOR FOCUSING

(71) Applicant: SICK AG, Waldkirch (DE)

(72) Inventors: Romain MÜLLER, Waldkirch (DE); Florian SCHNEIDER, Waldkirch (DE)

(21) Appl. No.: 16/712,389

(22) Filed: Dec. 12, 2019

(30) Foreign Application Priority Data
Dec. 13, 2018 (DE) 10 2018 132 015.9

(51) Int. Cl. G02B 3/14; G02B 7/02; G02B 7/08

(52) U.S. Cl. CPC G02B 3/14; G02B 7/08; G02B 7/028

(57) ABSTRACT

An optoelectronic sensor is provided comprising a light transmitter and/or a light receiver and an optics that is arranged in front of the light transmitter and/or the light receiver and that has an adaptive lens whose focal length is changeable, and having a control and evaluation unit that is configured to output a control signal to the adaptive lens to set a focal length and to determine a focusing time according to which the focal length is set, The control and evaluation unit is further configured to determine the focusing time in dependence on the change of the focal length to be set.

The invention relates to an optoelectronic sensor and to a method for focusing the optics of an optoelectronic sensor in accordance with the preambles of the respective independent claims.

A transmission optics and/or reception optics is/are provided in practically every optical sensor. This optics is frequently focused to a specific distance or distance range with the aid of a focal adjustment in that the position of the lenses and thus the back focal length of the transmission optics or reception optics is adjusted electromechanically or optomechanically, for example using stepper motors or moving coils. Such solutions require a lot of construction space and additionally make high demands on the mechanical design for the precise adjustability so that a predefined focal position is also actually adopted.

An alternative is the use of optics in which it is not the back focal length which is varied, but rather directly the shape and thus the focal length of the lens itself by means of a voltage control. Gel lenses or liquid lenses are in particular used for this purpose. With a gel lens, a silicone-like liquid is mechanically deformed by means of piezoelectric or inductive actuators. Liquid lenses, for example, utilize the so-called electrowetting effect in that two non-miscible liquids, preferably of similar densities, but having different refractive indices and electrical properties, are arranged above one another in a chamber. When a control voltage is applied, the two liquids change their surface tensions in different manners so that the inner boundary surface of the liquids varies its curvature in dependence on the voltage.

Liquid lenses have a much greater coefficient of temperature expansion than glass lenses and thermal influences are therefore especially large. Different approaches are known to counteract deviations between a desired and an actual focal position caused by temperature drifting or to compensate them.

The temperature of the liquid lens is measured and stabilized by a heating element and a feedback loop for this purpose in U.S. Pat. No. 9,575,221 B2. This is, however, relatively complex and/or expensive. It is conceivable to at least dispense with the heating element in that the control voltages are adapted using a correction matrix in dependence on the measured temperature of the liquid lens.

EP 2 924 974 A1 uses a special adaptive lens that is also tiltable and thus varies the direction of the optical axis. An image feature is monitored and a drift correction is determined from a comparison of its desired position and its drift correction. This is an indirect procedure that does not only use information of the adaptive lens. It requires the possibility of tilting the adaptive lens and of suitably detecting the image feature.

There is still a second problem in the compensation of thermal influences on the set focal length, namely the inertia of the adaptive lens. If detection is made by the sensor before the adaptive lens has adopted the desired focal position, this also results in interference effects even if the desired focal position were not to be reached at the end. It is now naturally possible always to wait a sufficiently long time with a sufficient safety buffer; however, this makes the sensor very slow.

In accordance with US 2011/0200314 A1, a camera therefore measures the temperature and waits for a temperature-specific time. This is admittedly faster than allowing a constant time to elapse, but still does not sufficiently consider the behavior of the adaptive lens and therefore does not utilize the possibilities for acceleration. An image detection is likewise prevented in WO 2006/061437 A1 as long as the liquid lens is setting a new focal length.

It is therefore the object of the invention to improve the change of focal positions using an adaptive lens

This object is satisfied by an optoelectronic sensor and by a method for focusing the optics of an optoelectronic sensor in accordance with the respective independent claims. The sensor uses an optics having an adaptive lens as a transmission optics of a light transmitter and/or as a reception optics of a light receiver. The focal length of the adaptive lens is changed by applying a control signal. A control and evaluation unit thus sets a respective desired focal position. It additionally determines a focusing time for how long it takes until the refocusing has been concluded, i.e. until the adaptive lens has set the new focal length. The sensor is again fully deployable with the new focal position after the focusing time.

The invention starts from the basic idea that refocusing processes take different amounts of time. The focusing time therefore depends on how great the change of the focal length is. In other words, the focusing time is a function of the difference of the new and previous focal lengths. A focusing time is therefore determined that is preferably not a constant and if it were, focusing times for the conceivable changes of the focal length would be determined and estimated as closely as possible upwardly to obtain this constant. The focusing time is not a measurement time; the focal length is not checked for its intended use, even if that would be conceivable as a supplement. The determination of the focusing time is rather based on assumptions that were, for example derived or taught from a model or a simulation.

The invention has the advantage that variable response times of the adaptive lens can be taken into account. The inertia is admittedly not overcome by this, but its influence on the required minimum is reduced. The detection with the sensor becomes faster and, since it is not necessary to work with a selected, but not yet adopted, focal position, also more accurate. The consideration in accordance with the invention of the focusing time can be very easily coordinated with the treatment of temperature effects as is shown in the following.

The control and evaluation unit is preferably configured to signal the end of the focusing time and/or to delay the further sensor function until the end of the focusing time. For this purpose, the sensor function can be fully blocked until the focusing time has elapsed; that is, it can only be triggered again after this. Alternatively, the elapse of the focusing time is used as a delayed trigger point for the further sensor function. It is thereby respectively ensured that the sensor does not already take up its further function before the desired focal position has actually been reached. The sensor function does not, however, have to be blocked; the sensor then, for example, works for so long in a mode that assumes greater errors due to insufficient focusing.

The control signal is preferably a voltage signal. The focal length of the adaptive lens is thus adjusted by application of the voltage predefined by the voltage signal or, in other words, by a voltage jump from the previously applied voltage to the new voltage predefined by the voltage signal. The focusing time is thus a function of the voltage jump ΔV.

The control and evaluation unit is preferably configured to determine the focusing time in dependence on the current focal length and on the focal length to be set. This is based on the recognition that the focusing time cannot only depend on the degree of the change of the focal length, but can also depend on which specific previous focal length is thus adjusted to which new focal length. In fact, two new parameters are not introduced, but rather only one is added, that is the current focal length or the focal length to be set. The second parameter of the focal length to be set or the current focal length is thereby also determined by difference determination using the degree of change of the focal length anyway taken into account in accordance with the invention. The focusing time is thus now a function of the current focal length and the new focal length or, equivalently, of the current focal length and the degree of change or of the degree of the change and of the new focal length. With a voltage signal as a control signal, the focusing time becomes a function of the previous voltage V1 and of the new voltage V2 or of V1 and ΔV: =V2−V1 or of ΔV and V2.

The sensor preferably has a temperature measurement unit for determining the temperature of the adaptive lens. This is used, for example, for a temperature compensation of the control signals.

The control and evaluation unit is preferably configured to determine the focusing time in dependence on temperature. The focusing time is thus determined even more accurately and is given an additional temperature dependence. The focusing time is accordingly now a function of the degree of change of the focal length and of the temperature or of the previous focal length, of the new focal length, and of the temperature. With a voltage signal as the control signal, the focusing time becomes a function of ΔV and T or of V1, V2, and T.

The sensor preferably has a temperature change element. It is a heating, a cooling, or both, in particular a Peltier element. Together with a temperature measurement unit, a closed loop can thus be set up for temperature stabilization; the temperature dependence of both the control signals and the focusing time is thus eliminated. It can, however, even be sensible to heat the adaptive lens without feedback simply only by a fixed or arbitrary heating power, at least a non-regulated heating power, since it then adopts a new focusing position faster. The temperature is preferably measured to also be able to determine and use the shorter focusing time thus achieved.

The sensor preferably has a memory with a lookup table (LUT) for focusing times. This memory is, for example, part of the control and evaluation unit; it at least has access thereto. On a refocusing, the previous and new focal lengths and possibly the current temperature, the focusing time, and thus the minimum waiting time until the adaptive lens has actually adopted the desired shape for the new focal position is read out of the table in dependence on the performance unit for the desired change of the focal length. Alternatively to the lookup table, a function or an algorithm can also be stored for the focusing time.

The dependence of the focusing time on possible changes of the focal length is preferably determined in advance in that a respective change is carried out, the focal position is evaluated with a quality criterion during the change, and the associated focusing time is determined as the time duration until a minimum quality criterion is reached, with the quality criterion in particular being a degree of contrast and/or with the minimum quality criterion being a percentage of a maximum quality criterion after a long waiting time. The conceivable refocusing processes are therefore carried out once or a multiple of times, possibly also at different temperatures. The intermediate positions of the focal length are evaluated, preferably via the contrast, during the adjustment of the focal length. As soon as this evaluation sufficiently approaches an optimum state, with the completely steady state preferably being able to be used as a benchmark after a time that is infinite for practical purposes, the refocusing is considered completed and the time duration required for this is stored as the associated focusing time. This determination of focusing times for their later determination on refocusing processes in operation can take place once for all the sensors of one design or individually for each sensor during its manufacture. A further possibility is an automatic procedure that is implemented in the control and evaluation unit and is carried out at the operating site, for example, during the setting up or during servicing.

The adaptive lens is preferably a liquid or gel lens and in particular has two non-miscible media whose mutual boundary surface has, due to application of a voltage, a curvature corresponding to the voltage. Such lenses provide the desired setting possibilities of the focal position and are very small in construction and inexpensive in this respect. They react relatively strongly to temperature fluctuations and display a very complex delay behavior on refocusing so that the invention is particularly advantageous for this purpose.

The sensor is preferably configured as a camera having an image sensor as the light receiver, with a shot only being triggered after the end of the focusing time after a refocus by setting a new focal length. The adaptive lens is here installed in the objective of the camera or is the objective. The camera blocks the triggering of shots during the focusing time or delays the triggering until after the focusing time.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

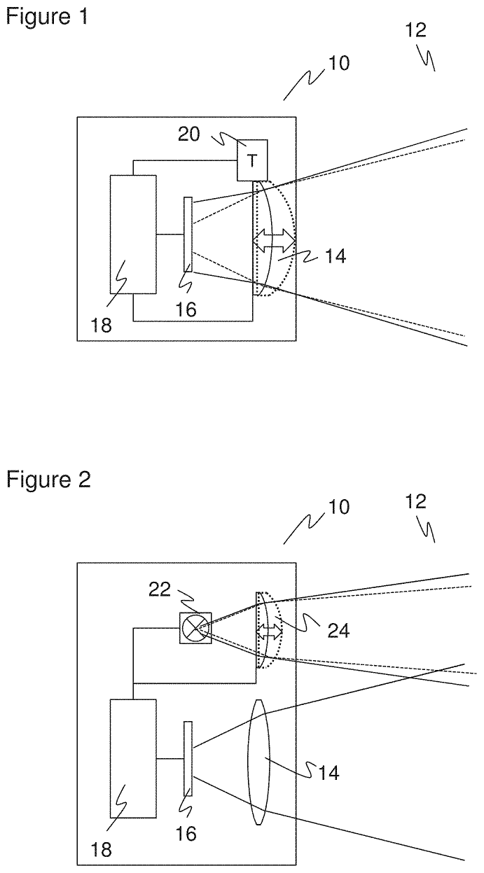

FIG. 1 a schematic sectional representation of an optoelectronic sensor with an adaptive lens in the reception optics;

FIG. 2 a schematic sectional representation of an optoelectronic sensor with an adaptive lens in the transmission optics;

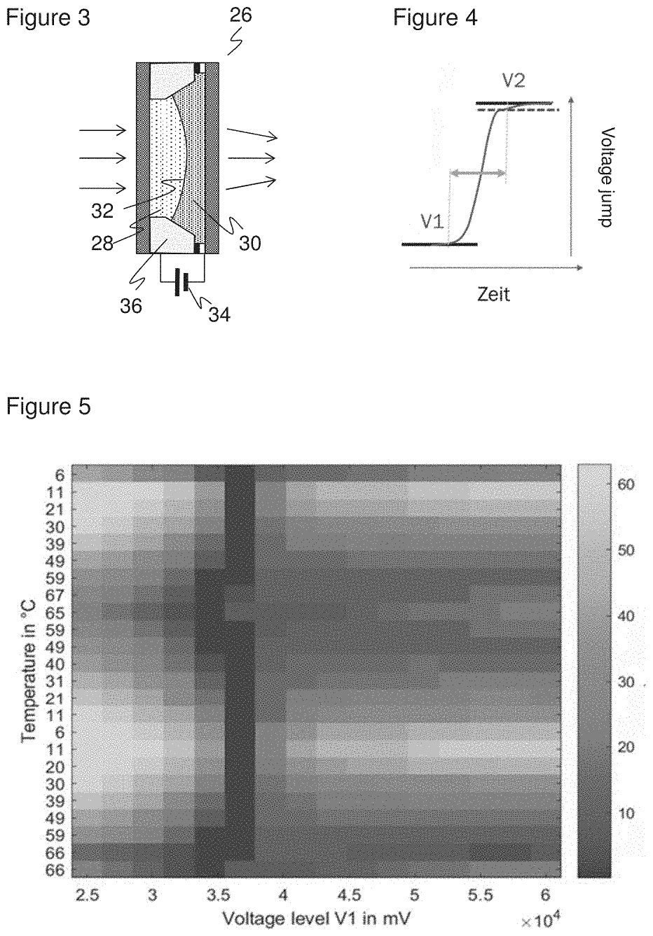

FIG. 3 a schematic representation of an adaptive lens in accordance with the invention;

FIG. 4 an exemplary representation of a voltage jump for controlling a refocusing; and

FIG. 5 a representation of the focusing times of an adaptive lens to a specific focal length in dependence on the previous focal length and on the temperature.

FIG. 1 shows a schematic sectional representation of an optoelectronic sensor for detecting object information from a monitored zone 12. An image sensor 16, for example a CCD or CMOS chip, generates shots of the monitored zone 12 via a reception optics 14. The image data of these shots are forwarded to a control and evaluation unit 18.

The reception optics 14 has an adaptive lens whose focal length can be changed by an electronic control of the control and evaluation unit 18. FIG. 1 shows by dashed lines by way of example an alternative focal length adjustment and the functional principle of a conceivable design of the adaptive lens will be explained in more detail below with reference to FIG. 3. The control and evaluation unit 18 is able to determine the focusing time that the adaptive lens requires to set the thus desired focal length after a control with a corresponding voltage. The further sensor function can thereby be blocked or delayed until the transient phase of the resetting of the focal length has been concluded. The determination of the focusing time will be explained in more detail below with reference to FIGS. 4 and 5.

A temperature unit 20 is arranged such that it is thermally connected to the adaptive lens. Depending on the embodiment, the temperature unit 20 has a temperature sensor for measuring the temperature of the adaptive lens and/or has a heating or cooling element for influencing this temperature, for example a Peltier element that can be configured as a ring.

In some applications, for instance in a cold store, adaptive lenses configured as liquid lenses do not work reliably and are then heated. Depending on the use, this also shortens the response time or focusing time until the adaptive lens has adopted a new focal length. An efficient heating element is sufficient for this purpose. A Peltier element, in contrast, is better suitable for a regulation or stabilization of the temperature since it changes the temperature in both directions, but only has a limited temperature difference.

FIG. 2 shows a further embodiment of the optoelectronic sensor 10. This embodiment differs from the embodiment shown in FIG. 1 by a light transmitter 22 having a transmission optics 24. The adaptive lens is now part of the transmission optics 24; the reception optics 14 has a fixed focal position. A temperature unit 20 as in FIG. 1 is also possible for the adaptive lens of the transmission optics 24 in the embodiment of FIG. 2. Mixed forms of the embodiments in accordance with FIG. 1 and FIG. 2 are furthermore conceivable in which the reception optics 14 and the transmission optics 24 have an adaptive lens or a common optics is provided having an adaptive lens for the image sensor 16 and for the light transmitter 22, with the adaptive lens in turn being able to have a temperature unit 20. In addition, a light transmitter 22 having a transmission optics without an adaptive lens can also be added in FIG. 1, for example to illuminate the monitored zone 12 or to generate a light signal whose time of flight is determined for the distance measurement.

FIGS. 1 and 2 are therefore schematic diagrams that are representative for a plurality of sensors. The sensor 10 in accordance with FIG. 1 is, for example, a camera with a variable focus that is inter alia suitable in a variety of applications for the inspection and measurement of objects, preferably in a stationary installation at a conveyor system that moves the objects through the monitored zone 12. A barcode scanner or a camera-based code reader arises by the use of processes of signal processing or image processing known per se to read codes. The image sensor 16 can have a linear arrangement or a matrix arrangement of pixels. In further embodiments, a different light receiver instead of an image sensor 16 is used, for example a photodiode or an APD (avalanche photodiode). The latter is, for example, used in a light sensor, in particular a distance measuring light sensor, or in a laser scanner.

The light transmitter 22 can also satisfy a variety of functions. For example, with the aid of the transmission optics 24, a specific illuminated monitored zone 12 is set, a sharp contrast pattern, a sharp target pattern to mark a recording or reading zone, or a sharp light spot is projected at a specific distance. Such different sensors 10 as a camera-based code reader, a code scanner, or a 3D camera are thus conceivable.

FIG. 3 shows the adaptive lens of the reception optics 14 or of the transmission optics 24 in an exemplary embodiment as a liquid lens 26 after the electrowetting effect. The operation will be explained with reference to this liquid lens 26, but the invention also comprises other adaptive lenses, for example those having a liquid chamber and having a membrane which covers it and whose curvature is varied by pressure on the liquid, or having lenses with a gel-like, optically transmitting material which is mechanically deformed by an actuator.

The actively tunable liquid lens 26 has two transparent, non-miscible liquids 28, 30 having different refractive indices and having the same densities. The shape of the liquid boundary surface 32 between the two liquids 28, 30 is used for an optical function. The activation is based on the principle of electrowetting which shows a dependence of the surface tension or of the boundary surface tension on the applied electrical field. It is therefore possible to vary the shape of the boundary layer 32 and thus the optical properties of the liquid lens 26 by an electric control at a terminal 34, whereby corresponding voltages are applied to an electrode 36. In addition to an adjustment of the focal length, a tilting is also conceivable for which purpose then at least one further electrode is provided at the liquid lens 26.

A determination of the focusing time by the control and evaluation unit 18, that is that response time of the liquid lens 26 until, after a control by a voltage for a desired new focal position, it has actually adopted the shape for this focal length, will now be described with reference to FIGS. 4 and 5. The focusing time will here be looked at as a function F(V1, V2, T) of the temperature T of the liquid lens 26, of the previously applied voltage V1, and of the newly applied voltage V2.

The function F can be stored as such or as a lookup table in a memory of the sensor 10. The control and evaluation unit 18 is aware of the voltages V1 and V2 since it is responsible for the adjustment of the liquid lens 26 and determines the temperature via the temperature unit. The associated focusing time can thus be read out of the lookup table.

To acquire the function F(V1, V2, T) in advance, the focusing time F is measured for a plurality of tuples (V1, V2, T). Intermediate values can be modeled or interpolated. It is sensible in operation to correct the voltage V2 using a temperature dependent compensation function. This is, however, not done in the following for reasons of simplicity.

FIG. 4 illustrates the measurement of a single focusing time. At the start, the liquid lens 26 has adopted a focal length corresponding to the voltage V1. The liquid lens 26 is now controlled by a voltage jump ΔV to V2 and then reaches the new focal length V2 after the focusing time. To evaluate when the new focal length has been reached, images of a high contrast object are recorded at a distance corresponding to the new focal length V2 in short time intervals of, for example, 100 μs and the contrast of these images is determined.

The contrast progression over the images and thus over time is the curve shown in FIG. 4. The contrast is initially not yet high since the liquid lens 26 has not yet reacted quickly enough due to its inertia. The contrast then increases and reaches a maximum after a sufficiently long time. A proportion of this maximum of, for example, 90% is marked by a dashed line and the required time duration until then is used as the focusing time for this voltage jump. Such measurements are now carried out for a plurality of tuples (V1, V2, T), with multiple measurements with averaging also being possible for the same tuple.

FIG. 5 shows the result of such measurements for a fixed value of V2, with the numerical value for V2 being 34 V purely by way of example. The varied voltage V1 is applied on the X axis; the varied temperature on the Y axis, with here the scale not being ordered, but rather corresponding to the measurement series of the respective temperatures actually set for the measurement. The focusing time measured in accordance with FIG. 4 is coded by color or gray value. In other words, FIG. 5 shows a section through the function F(V1, V2, T) for a fixed V2=34 V. The total function F(V1, V2, T) would have yet a further dimension with a varying V2 and would not be presentable in this manner, but can nevertheless be determined and stored in the memory of the sensor 10.

The focusing time decreases with the temperature in accordance with FIG. 5. It is still at a maximum 60 ms at 60° C. and only 20 ms at 65° C. If V1 and V2 approach one another, the focusing time becomes very small at <5 ms. The voltage V1 at which the response time is minimized, is close to the focusing voltage V2. but has slight temperature dependencies. The latter could be an artifact of the partially indirect determination of the voltages and temperatures in the acquisition of the data for FIG. 5.

The function F(V1, V2, T) acquired in this manner can now be used for a passive system without temperature regulation. It is ensured after the elapse of the focusing time that the inertia of the liquid lens 26 is overcome and the desired focal position is set. It is ensured with F(V1, V2, T) that an unnecessarily long time is not waited for this, but the sensor 10 is rather available again as fast as possible after each individual refocus. In a somewhat simpler embodiment, a function F(ΔV, T) where ΔV: =V2−V1 is used at which the focusing time only depends on the degree of the change and not on the specific starting time or end time. The function F(ΔV, T) can naturally also be acquired by simplification from F(V1, V2, T).

If, as described with respect to FIG. 1, the temperature is additionally regulated or stabilized, the temperature dependence of the focusing time can be eliminated. Since then thermal effects no longer occur, the function for the focusing time is simplified from F(V1, V2, T) to F(V1, V2) or from F(ΔV, T) to F(ΔV).

1. An optoelectronic sensor comprising a light transmitter and/or a light receiver and an optics, the optics being arranged in front of at least one of the light transmitter and the light receiver and the optics having an adaptive lens whose focal length is changeable, and the optoelectronic sensor further comprising a control and evaluation unit that is configured to output a control signal to the adaptive lens to set a focal length and to determine a focusing time according to which the focal length is set,
wherein the control and evaluation unit is further configured to determine the focusing time in dependence on the change of the focal length to be set.

2. The optoelectronic sensor in accordance with claim 1,
wherein the control and evaluation unit is configured to signal the end of the focusing time.

3. The optoelectronic sensor in accordance with claim 1,
wherein the control and evaluation unit is configured to delay the further sensor function until the end of the focusing time.

4. The optoelectronic sensor in accordance with claim 1,
wherein the control signal is a voltage signal.

5. The optoelectronic sensor in accordance with claim 1,
wherein the control and evaluation unit is configured to determine the focusing time in dependence on the current focal length and on the focal length to be set.

6. The optoelectronic sensor in accordance with claim 1,
that has a temperature measurement unit for determining the temperature of the adaptive lens.

7. The optoelectronic sensor in accordance with claim 1,
wherein the control and evaluation unit is configured to determine the focusing time in dependence on the temperature.

8. The optoelectronic sensor in accordance with claim 1,
that has a temperature changing element.

9. The optoelectronic sensor in accordance with claim 1,
that has a memory having a lookup table for focusing times.

10. The optoelectronic sensor in accordance with claim 1,
wherein the dependence of the focusing time on possible changes of the focal length is determined in advance in that a respective change is carried out, the focal position is evaluated with a quality criterion during the change, and the associated focusing time is determined as the time duration until a minimum quality criterion is reached.

11. The optoelectronic sensor in accordance with claim 10,
wherein the quality criterion is a degree of contrast, and/or wherein the minimum quality criterion is a percentage of a maximum quality criterion after a long waiting time.

12. The optoelectronic sensor in accordance with claim 1,
wherein the adaptive lens is one of a liquid lens and a gel lens.

13. The optoelectronic sensor in accordance with claim 12,
wherein the adaptive lens has two non-miscible media whose mutual boundary surface has, due to application of a voltage, a curvature corresponding to the voltage.

14. The optoelectronic sensor in accordance with claim 1,
that is configured as a camera having an image sensor as the light receiver, with a shot only being triggered after the end of the focusing time after a refocusing by setting a new focal length has of the adaptive lens.

15. A method of focusing the optics of an optoelectronic sensor, wherein the optics has an adaptive lens whose focal length is changed by at least one of a control signal and a voltage signal, with a focusing time according to which the focal length is set being determined on the adjustment of the focal length, and
with the focusing time being determined in dependence on the change of the focal length to be set.

16. The method in accordance with claim 15,
wherein the focusing time is set in dependence on the current focal length and on the focal length to be set.

17. The method in accordance with claim 16,
wherein the focusing time is set in dependence on a voltage jump between the voltage signals for the setting of the current focal length and the focal length to be set.

18. The method in accordance with claim 15,
wherein the temperature of the adaptive lens is measured and the focusing time is also determined in dependence on the temperature.

19. The method in accordance with claim 15,
wherein the dependence of the focusing time on possible changes of the focal length is determined in advance in that a respective change is carried out, the focal position is evaluated with a quality criterion during the change, and the associated focusing time is determined as the time duration until a minimum quality criterion is reached.

20. The method in accordance with claim 19,
wherein the quality criterion is a degree of contrast and/or wherein the minimum quality criterion is a percentage of a maximum quality criterion after a long waiting time.
